(19) United States
(12) Patent Application Publication
(10) Pub. No.: US 2018/0115740 A1
(43) Pub. Date: Apr. 26, 2018

(54) METHOD AND SYSTEM FOR PROJECTING AN IMAGE BASED ON A CONTENT TRANSMITTED FROM A REMOTE PLACE

(71) Applicant: Panasonic Intellectual Property Management Co., Ltd., Osaka (JP)

(72) Inventor: Nobutaka KODAMA, Fukuoka (JP)

(73) Assignee: Panasonic Intellectual Property Management Co., Ltd., Osaka (JP)

(21) Appl. No.: 15/791,865

(22) Filed: Oct. 24, 2017

Related U.S. Application Data
(60) Provisional application No. 62/412,431, filed on Oct. 25, 2016.

(51) Int. Cl. H04N 7/01; H04N 9/31; H04L 29/08

(52) U.S. Cl. CPC H04N 7/01; H04N 21/4122; H04L 67/12; H04N 9/31

(57) ABSTRACT

A system and method for projecting a content image, the system and method comprises, receiving a plurality of content data each including at least text data transmitted from a content provider, receiving a plurality of instruction data each indicating a display format, selecting first content data from the received plurality of content data, generating a first image based on the selected first content data in accordance with first instruction data which is one of the plurality of instruction data and correspond to the first content data, and projecting by a projector the generated first image, wherein the first image includes at least characters generated by editing text data in accordance with a display format indicated by the first instruction.

### BACKGROUND

### 1. Field of the Disclosure

The present disclosure relates to the field of sharing information by using a network. More particularly, the present disclosure relates to projecting an image based on a content transmitted from a remote place.

### 2. Background Information

In recent years, IoT (Internet of Things) technologies or devices attract rising attention. In an IoT age, any devices are expected to be connectable to a network and a projector is not an exception to the expectation.

### SUMMARY

A system for projecting a content image, the system comprising: a processor; a memory storing instructions, that when executed by the processor, cause the processor to perform operations including: receiving a plurality of content data each including at least text data transmitted from a content provider; receiving a plurality of instruction data each indicating a display format; selecting first content data from the received plurality of content data; generating a first image based on the selected first content data in accordance with first instruction data which is one of the plurality of instruction data and correspond to the first content data; and projecting by a projector the generated first image, wherein the first image includes at least characters generated by editing text data in accordance with a display format indicated by the first instruction.

A method for projecting a content image, the method comprising: receiving a plurality of content data each including at least text data transmitted from a content provider; receiving a plurality of instruction data each indicating a display format; selecting first content data from the received plurality of content data; generating a first image based on the selected first content data in accordance with first instruction data which is one of the plurality of instruction data and correspond to the first content data; and projecting by a projector the generated first image, wherein the first image includes at least characters generated by editing text data in accordance with a display format indicated by the first instruction.

A system for projecting a content image, the system comprising: a content manager that communicates with a plurality of content providers generating content data including at least text data via a network and a plurality of projectors projecting an image generated based on the content data generated by the content providers; wherein the content manager receives the content data and brief instruction data with respect to the received content data, translates the brief instruction data into specific instruction data that instructs a method for generating an image based on the content data, and transmits the content data and the specific instruction data with respect to the content data to the projectors.

### BRIEF DESCRIPTION OF THE DRAWINGS

FIG. 1 shows an exemplary system for projecting contents transmitted from outside, according to an aspect of the present disclosure;

FIG. 2 shows an exemplary flowchart of a system for projecting contents transmitted from outside, according to an aspect of the present disclosure;

FIG. 3 shows an exemplary schematic of a system for projecting contents transmitted from outside, according to an aspect of the present disclosure;

FIG. 4 shows an exemplary explanation for generating instructions, according to an aspect of the present disclosure;

FIG. 5 shows an exemplary flowchart of a content output system, according to an aspect of the present disclosure;

FIG. 6 shows an exemplary images generated based on text data and instructions indicating a data format by a content output system, according to an aspect of the present disclosure;

FIG. 7 shows an exemplary table showing several specific instruction examples, according to an aspect of the present disclosure;

FIG. 8 shows an exemplary flowchart of a content output system, according to an aspect of the present disclosure;

FIG. 9 shows an exemplary flowchart of a content output system, according to an aspect of the present disclosure;

FIG. 10 shows an exemplary time schedule for contents, according to an aspect of the present disclosure;

FIG. 11 shows an exemplary projected image with a content image, according to an aspect of the present disclosure;

FIG. 12 shows an exemplary explanation for processes for projecting more text dada, according to an aspect of the present disclosure;

FIG. 13 shows an exemplary system for projecting contents transmitted from outside, according to an aspect of the present disclosure

FIG. 14 shows an exemplary schematic of a system for projecting contents transmitted from outside, according to an aspect of the present disclosure;

FIG. 15 shows an exemplary schematic of a system, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are non-limiting illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

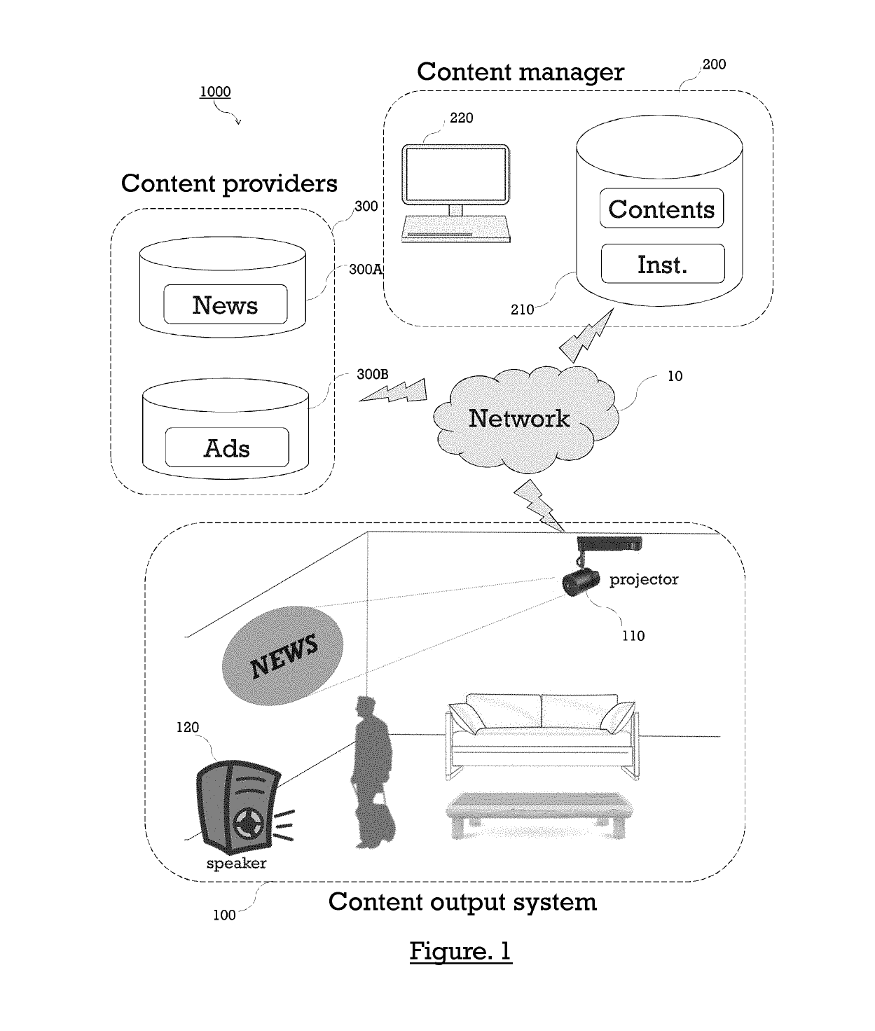

FIG. 1 shows an exemplary system for projecting contents transmitted from outside, according to an aspect of the present disclosure. A system 1000, for projecting contents transmitted via a network 10, includes one or more contents output systems 100 and a content managing system (contents manager) 200 transmitting contents to the content output system 100 via the network 10. The network 10 may be a wired network, a wireless network or a combination thereof. The system 1000 may or may not include content providing group (content providers) 300 which is resources for content projected by the content output system 100. The content providing group 300 include a content provider 300A such as a news company having news contents and a content provider 300B such as a sales company having advertisement contents for promoting products of the sales company. The content providing group 300 may include more other providers. The content providers 300A and 300B may or may not be the same entity such as company, firm, business unit, association, organization, or like that. In similar, all of or a part of the content providing group 300 may or may not be the same entity as an operator of the content managing system 200 and/or the content output system 100. For example, if the content provider 300A is a different entity from the operator of the content managing system 200, the operator may make a contract with the content provider 300A for distributing contents of the content provider 300A via the operator's facilities such as the content output system 100. In this case, the content provider 300A would make a payment for the distribution to the operator of the content managing system 200. The content provided by the content providing group 300 may include any information other than the news contents and advertisement contents described above as examples.

The content managing system 200 include a content server 210, and may further include a computer 220 for inputting information to the content server 210. The content server 210 performs a management for controlling or operating contents described hereinafter in detail. Each of the content providers 300A and 300B transmits their contents (e.g., news or Ads) to the content server 210 via the network 10. Then the content server 210 receives the contents and stores them in a memory. The content providers 300A and 300B may also transmit instructions which correspond to the transmitted contents and indicate display formats for the transmitted contents when projecting the contents, and preset instructions managing the contents and/or instructions. Then the content server 210 receives the instructions and the preset instructions, then stores them in a memory. The computer 220 may have a display and any inputs such as a mouse, a keyboard, a touch panel, like that. The computer 220 may input the contents, the instructions or the preset instructions to the content server 210 as well as the content providing group 300.

The content output system 100 includes a projector 110, and may further include a speaker 120. The projector 110 receives contents and instructions from the content server 210 via the network 10, generates an image based on one of the received contents, then projects the generated image on a wall. The projector 110 may be attached and fixed on a ceiling or a wall in a certain room, and may project the generated image on any places other than the wall. In addition, when the contents include music data, the speaker 120 may output the music.

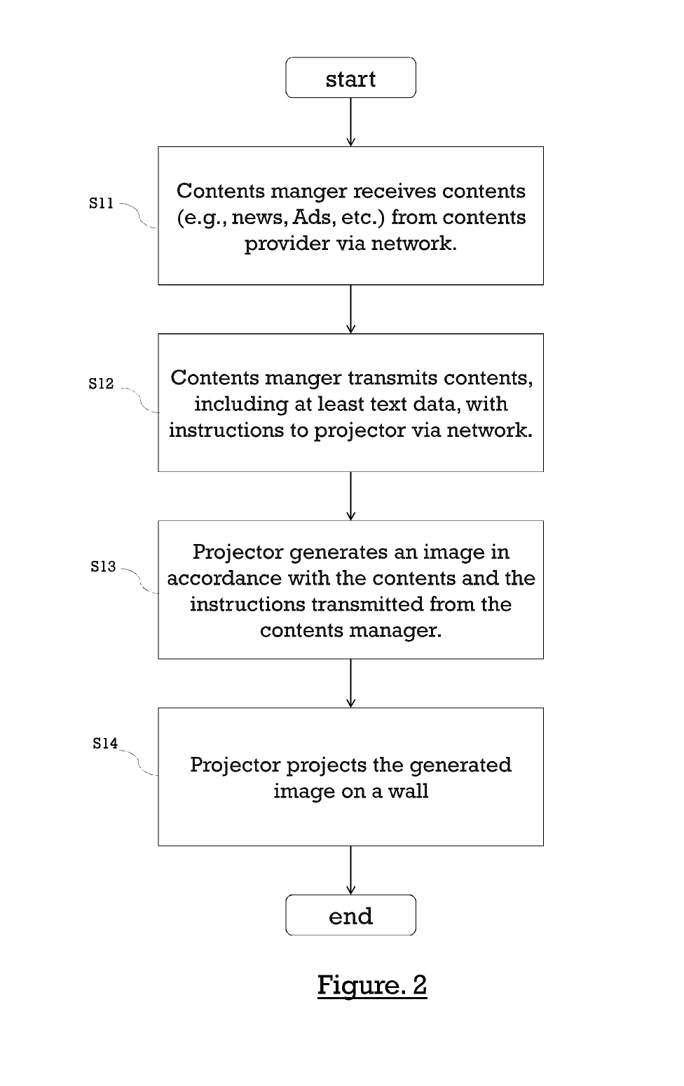

FIG. 2 shows an exemplary flowchart of a system for projecting contents transmitted from outside, according to an aspect of the present disclosure. In step S11, one or more of the content providing group 300 transmit their contents to the content server 200 via the network 10. Then the content server 200 receives the transmitted contents. The content providing group 300 may transmit instructions indicating data formats with respect to the transmitted contents. In step S12, the content server 210 transmits the contents including at least text data with the instructions to the projector 110 via the network 10. In step S13, the projector 110 generates an image in accordance with one of the contents and an instruction corresponding to said one of the contents. In step S14, the projector 110 project the generated image on a wall.

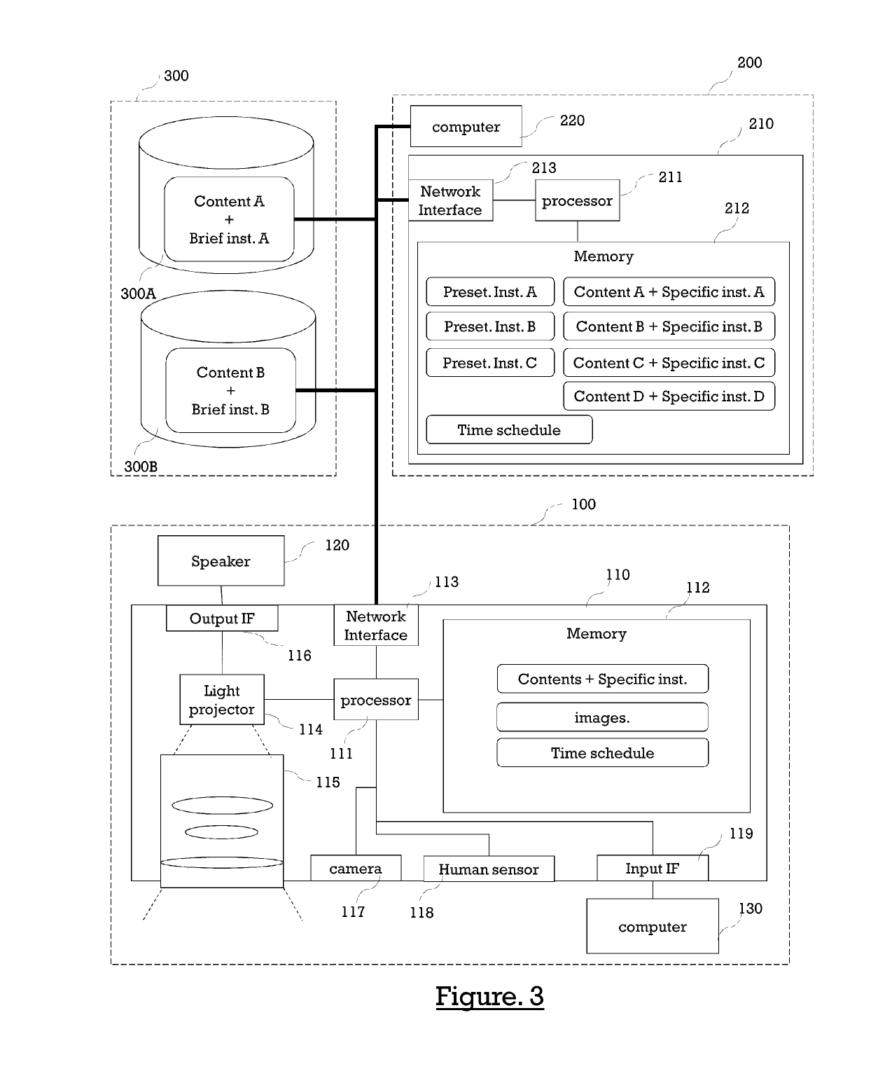

FIG. 3 shows an exemplary schematic of a system for projecting contents transmitted from outside, according to an aspect of the present disclosure. Herein, it is explained about the system 1000 in more detail with FIG. 3. The content server 210 may include a processor 211, a memory 212 and a network interface (IF) 213. The network interface 213 is an interface for the network 10 in order to communicate with other devices (e.g., the content providers 300A and 300B, the content output system 100 including for example the projector 110 and the speaker 120). Thus the network IF 213 may be a transmitter and/or a receiver for content data and instruction data. The processor 211 is a main controller of the content server 210. The processor 211 receives content data and/or instruction data from the content providing group 300 via the network IF 212, then stores the received content data and/or instruction data in the memory 212.

The processor 211 may translate the received instruction data into an actual instruction data designating a display form specifically based on a preset instruction. For instance, the content provider 300A transmits content data A with brief instruction data A to the content server 210. In this case, the content server 210 has preset instruction data A corresponding to the content provider 300A and preset instruction B corresponding to the content provider 300B. The preset instruction data A and the preset instruction B are registered in advance by their correspondent providers. The content providers 300A and 300B may transmit their preset instruction data A and B in order to be stored in the memory 212 by the processor 211. Otherwise, the operator of the content managing system 200 may input the preset instruction data A in response to requests from the content provider 300A and/or the preset instruction data B in response to requests from the content provider 300B. In such a situation, when the processor 211 receives the brief instruction data A with respect to the content data A from the content provider 300A, the processor 211 confirms a source of the brief instruction data A, then translates the brief instruction data A into the specific instruction data A in accordance with the preset instruction data A corresponding to the content provider 300A. The specific instruction data B is translated similarly. The specific instruction data A (or B) designates a display format with respect to the content data A (or B) more specifically. Therefore the system 1000 could reduce communication traffics between the content providing group 300 and the content managing system 200 because the content providing group 300 is not necessary to send specific instruction data to the content server 210 every time. However, the content providing group 300 may certainly transmit specific instruction data to the content server 210. For instance, specific instruction data D with respect to content data D is directly transmitted from another content provider, other than the content providers 300A and 300B, who has not registered preset instruction data. In addition, the processor 211 may generate time schedule for each content (then store it in the memory 212).

The projector 100 includes a processor 111 as a main controller for the content output system 100, a memory 112 for stocking contents received from the content server 210, a network interface (IF) 113 as a transmitter and/or receiver, a light projector (light sources) 114 for projecting an image generated based on one of contents in the memory 112, lens unit 115 being structured by a plurality of lens which may be movable. The processor 111 receives, via the network IF 113, a plurality of content data with correspondent specific instruction data transmitted from the content server 210 via the network 10. In addition, the processor 111 may receive the time schedule generated by the content server 210. Then the processor 111 selects one of contents stored in the memory 112 according to the time schedule, generates an image based on the selected contents and specific instruction data thereof, and cause the light projector 114 to project the generated image via the lens unit 115. As a result, the content output system 100 can let people see the image showing information sent from a remote place. The generated image may be stored in the memory 112 in volatile or non-volatile, or deleted after projecting it.

The projector 110 further include an input interface (IF) 119 for receiving image data from peripheral computer 130 which may or may not be a part of the content output system 100. As described below, the processor 111 may also project a content during projecting the image data input by the peripheral computer 130. Otherwise, the processor 111 may stop projecting a content when projecting the image data input by the peripheral computer 130. The projector 110 may further include an output interface (IF) 116 for outputting data with respect to content data stored in the memory 112. For instance, if one of content data include music data, the projector 110 may output the music data to a speaker 120 to play it. In addition, in case that the processor 111 generates an image based on the content data including the music data, the processor 111 may control the light projector 114 and the speaker 120 such that both devices work at the same time. In other word, the processor 111 may cause the speaker 120 to play the music data when the generated image based on the content including the music data is projected. The projector 110 may further include a camera 117 for picturing and a human sensor for sensing a human nearby the projector 110.

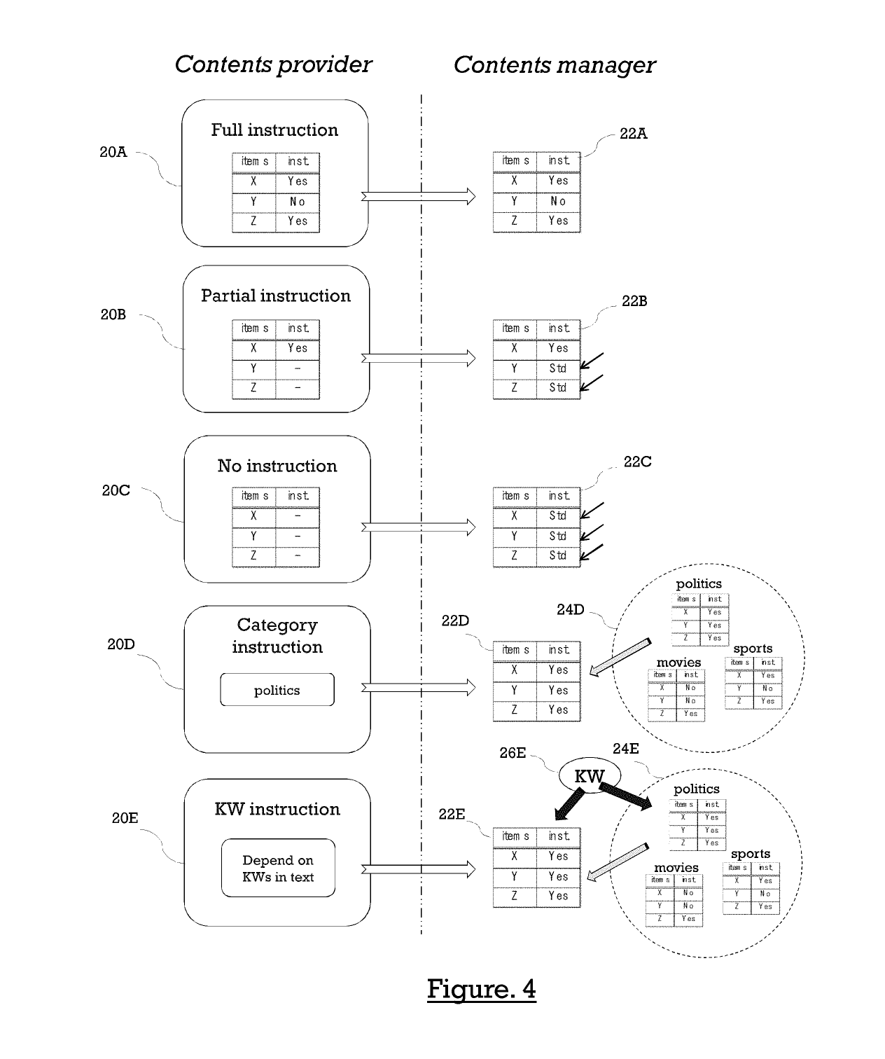

FIG. 4 shows an exemplary explanation for generating instructions, according to an aspect of the present disclosure. As described above, the processor 211 of the content server 210 may translate received instruction data from the content providing group 300 into transmitted instruction data to the content output system 100. Herein, some examples for the translation are explained.

As a first example, it is explained about a case of a full instruction. An original instruction data 20A which is provided by the content providing group 300 and transmitted to the content managing system 200 include the full instruction. In this case, the processor 211 does not perform a translation because the original instruction data 20A, as the full instruction, has already all of information which designates all of items (elements) X, Y and Z being necessary for determining a display format of a content with respect to the original instruction data 20A. Thus the processor 211 does not change any information about the original instruction data 20A. In other word, the specific instruction data 22A is the same information as the original instruction data 20A, substantially.

As a second example, it is explained about a case of a partial instruction. An original instruction data 20B which is provided by the content providing group 300 and transmitted to the content managing system 200 is translated into specific instruction data 22B by the processor 211. The original instruction data 20B include the partial instruction designating about the item X, but not about the item Y and Z. In this case, the processor 211 checks preset instruction data which is stored in the memory 212 and registered by a content provider being a source of the original instruction data 20B because the original instruction data 20B, as the partial instruction, do not include all of information for determining a display format. In the second example, the preset instruction data define standard settings for each item based on requirements from the content provider 300 being a source of the original instruction data 20B, and instruct that the standard settings are used to items unless the items are instructed with respect to a display format in the original instruction data 20B. Therefore, for generating the specific instruction data, the item X is determined from the original instruction data 20B. On the other hand, the items Y and Z are applied by the standard settings due to lacks of designations for the item Y and Z by the original instruction data 20B. Thus the standard settings are not limited to a specific item. The standard settings may be applicable to any items.

As a third example, it is explained about a case of no instruction for a data format. An original instruction data 20C which is provided by the content providing group 300 and transmitted to the content managing system 200 is translated into the specific instruction data 22C by the processor 211. The original instruction data 20C do not include instructions for a data format, in other word, do not designate about the items X, Y, and Z. In this case, standard settings defined by preset instruction data which is stored in the memory 212 and registered by a content provider being a source of the original instruction data 20C are used as well as the second example. Thus all of the items X, Y and Z are applied by the standard settings for generating the specific instruction data 22C.

As a forth example, it is explained about a case of a category instruction. An original instruction data 20D which is provided by the content providing group 300 and transmitted to the content managing system 200 is translated into the specific instruction data 22D by the processor 211. The original instruction data 22D merely designates a category of a content (such as politics, sports, movies, or like that). However, preset instruction data 24D stored in the memory 212 includes a plurality of patterns defining specific instruction data for each category (politics, sports and movies). Thereby, when the processor 211 receives the original instruction data 22D indicating “politics” as a category, the processor 211 selects one of the patterns corresponding to the “politics” and registers the selected pattern as the specific instruction data 22D.

As a forth example, it is explained about a case of a keyword instruction. An original instruction data 20E which is provided by the content providing group 300 and transmitted to the content managing system 200 is translated into the specific instruction data 22E by the processor 211. The processor 211 extracts keywords 26E from text data of a content upon receiving the original instruction data 20E, as the keyword instruction. Then the processor 211 may determine a category in accordance with the extracted keywords 26E. For example, if the processor 211 determines the category of the content corresponding to the original instruction data 22D as a “politics”, the processor 211 selects a certain specific instruction corresponding to “politics” among from instruction patterns (for politics, sports, movies) stored in the memory 212. Then the selected specific instruction data is registered as the specific instruction data 22E. In another option, the processor may generate the specific instruction data 22E based on the extracted keywords 26E without determining the category.

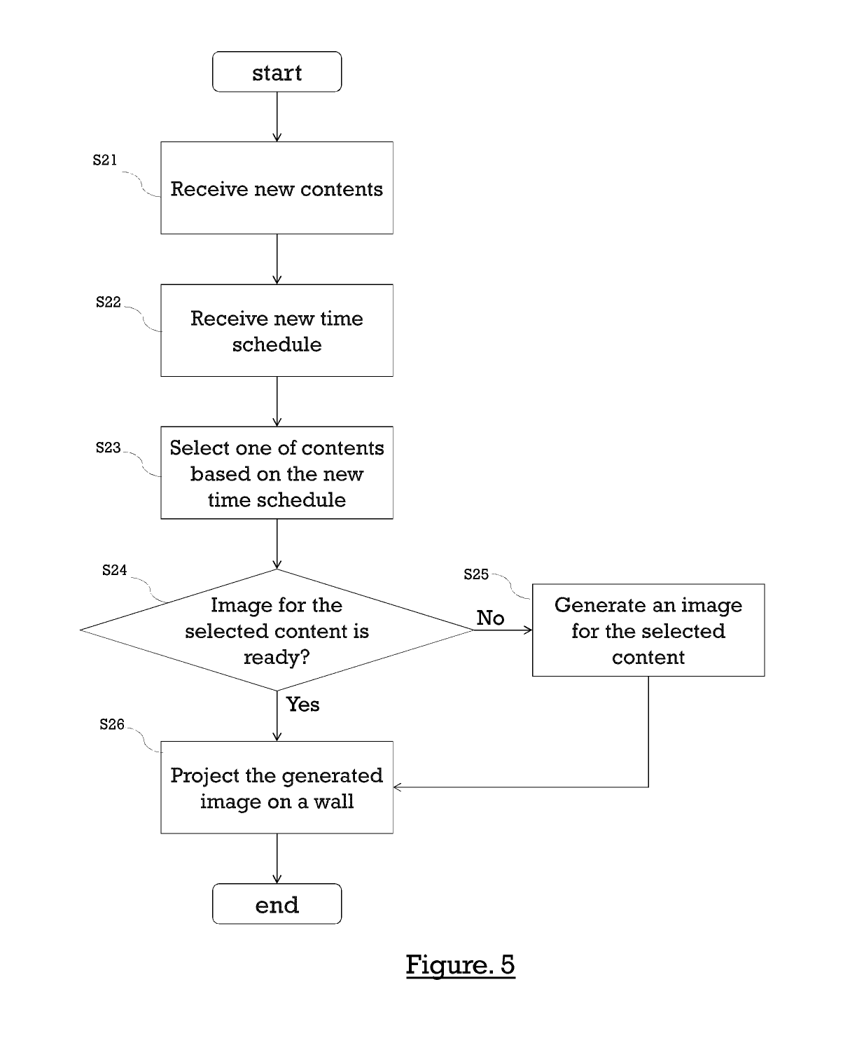

FIG. 5 shows an exemplary flowchart of a content output system, according to an aspect of the present disclosure. In step S21, the processor 111 of the projector 110 receives new content data with specific instruction data from the content server 210 via the network 10, then stores them in the memory 112. In step S22, the processor 111 further receives new time schedule generated by the content server 210 in light of the new content data, then stores them in the memory 112. Hence, the new time schedule indicates time for the new content data as well as time for old content data that the projector 110 had already received. In step S23, the processor 111 selects one content from contents including the new content data and the old content data according to the new time schedule. In step S24, the processor 111 confirms if an image corresponding to the selected contents has generated. When the image is not ready (No of S24), the processor 111 generate the image for the selected content data. In step S26, the processor 111 projects the image on a wall.

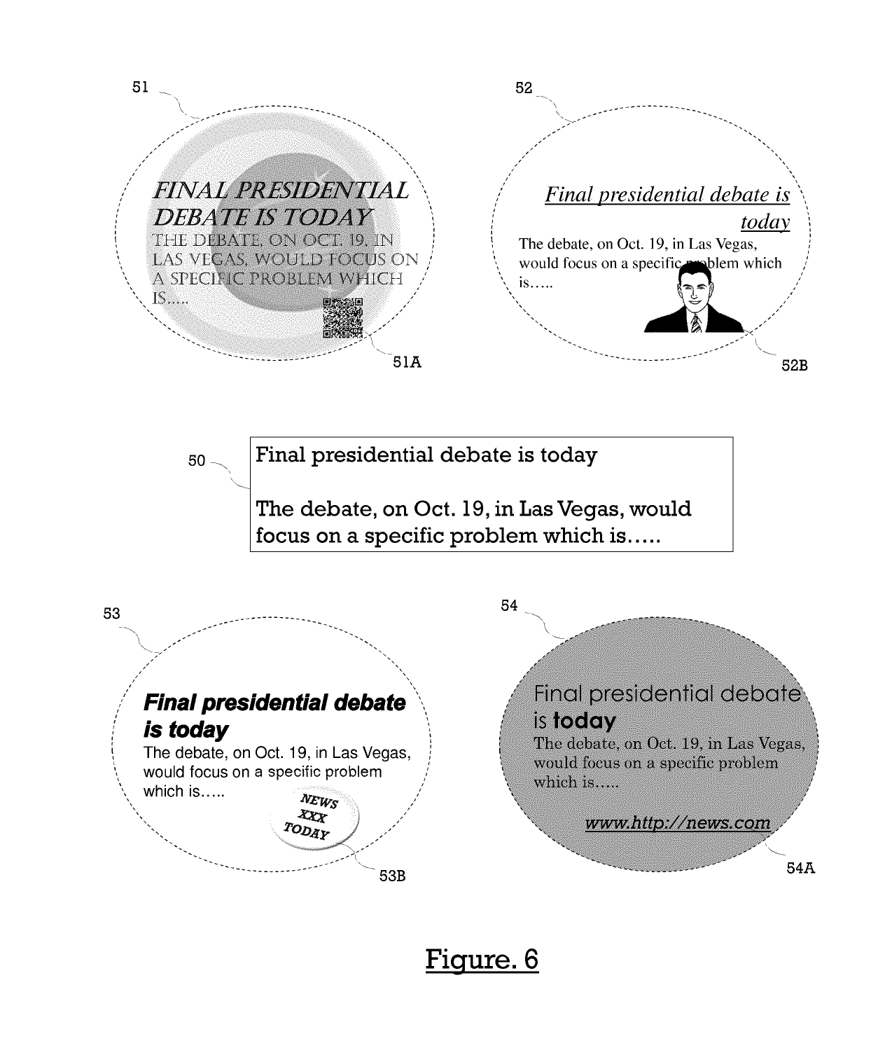

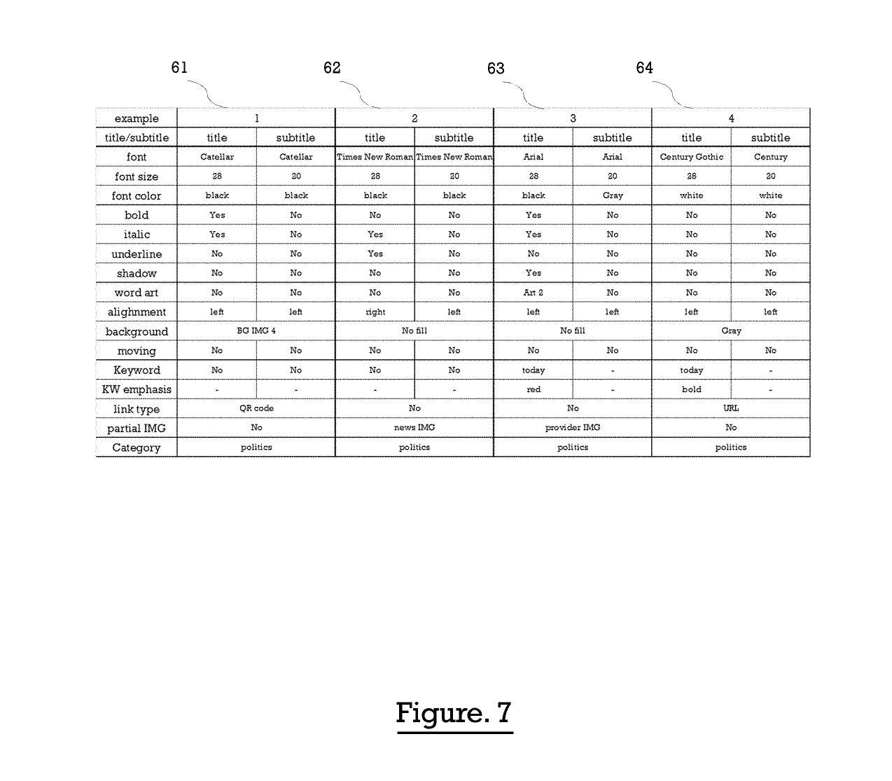

FIG. 6 shows an exemplary images generated based on text data and instructions indicating data format by a content output system, according to an aspect of the present disclosure. FIG. 7 shows an exemplary table showing several specific instruction examples, according to an aspect of the present disclosure. Text data 50 is included in a certain content, and all of images 51-54 are generated by the processor 111 based on the same source, the text data 50, according to different instructions 61-64. In detail, the image 51 is generated based on the text data 50 with the specific instruction data 61, the image 52 is generated based on the text data 50 with the specific instruction data 62, the image 53 is generated based on the text data 50 with the specific instruction data 63, and the image 54 is generated based on the text data 50 with the specific instruction data 64.

The text data 50 include title text data which correspond to “Final presidential debate is today” and subtitle text data which correspond to “The debate, on Oct. 19, in Las Vegas, would focus on a specific problem which is . . . ” in FIG. 6. Then the specific instruction data 61-64 instruct for each the title text data and the subtitle text data with respect to items for a display format, the items including a font, a font size, a font color, bolded or not, italic-ed or not, underlined or not, shadowed or not, an alignment, moved or not, emphasized by a keyword search.

In addition, the image 51 includes “BG IMG 4”, as a background image, behind the characters. A plurality of background images may be stored in the memory 112 in advance such that the processor 111 can pick up one of background images when generating an image in response to an instruction. Further the image 51 include QR code 51A, as a link information, to be connected to a web page showing detail information about a content of the image 51. In this case, the image 51 discloses merely a short topic for political news. If a person, however, read the link information with his/her personal device (e.g., a mobile phone, a tablet, or a PC), the personal device can be transferred to the web page displaying the detail information, like whole text for that news.

The image 52 includes a news IMG 52B, as a partial image, which is displayed with characters and is not fully overlapped with the characters. The partial image 52B may be transmitted from the content providing group 300 to the projector 110 via the content server 210, as a part of the specific instruction data. The image 53 includes a provider IMG 53B, as a partial image, which is displayed with characters and is not fully overlapped with the characters. The provider IMG 53B may correspond to a logo or a trade mark with respect to a content provider of the image 53. The provider IMG 53B may be stored in the memory 112 in advance. In addition, the specific instruction data 53 designate “today” as a keyword, to be emphasized in red. Thus “today” within the title text of the image 53 becomes red color to be emphasized. Similarly, “today” within the title text of the image 54 is emphasized in bold. Also the image 54 includes URL 54A as link information to be connected to a web page showing detail information about a content of the image 54, as well as the image 51.

In addition, the projector 110 may transmit a signal, as link information, by visible light communication instead of QR code or URL. Thus the processor 111 may control the light projector 114 to broadcast a certain light pattern within a predetermined range which may provide specific link information. Then the light pattern may be captured by a camera of mobile device (e.g., mobile phone) and be accessed to a web page showing detail information.

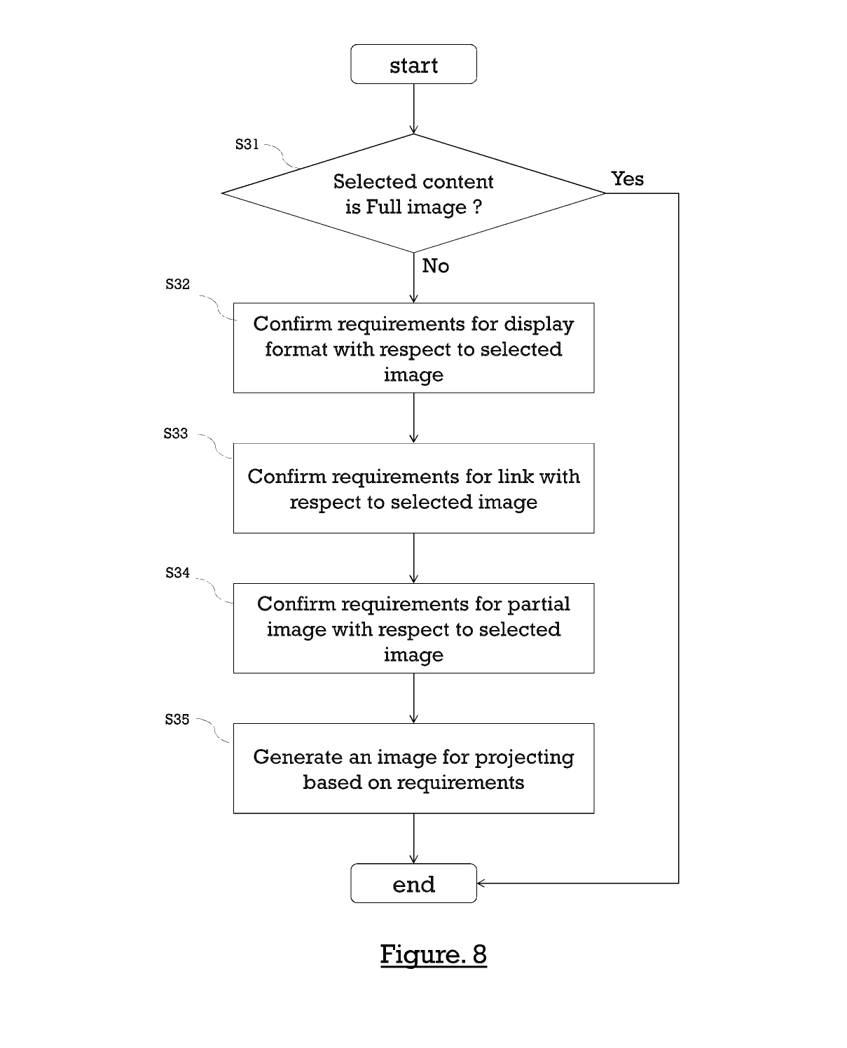

FIG. 8 shows an exemplary flowchart of a content output system, according to an aspect of the present disclosure. FIG. 8 shows how to generate an image (such as the images 51-54) for projecting and one of examples in associated with detailed processes of step S25 in FIG. 5. In step S31, the processor 111 confirms if the selected contents data correspond to a full image. If it does (Yes of S31), the full image is projected by the processor 111 without changing anything about the full image. The content providers 300 may transmit such full image in place of text-based contents. In step S32, the processor 111 confirms requirements for a display format with respect to the selected image (e.g., a font, a font size, a font color, bolded or not, italic-ed or not, underlined or not, shadowed or not, an alignment, moved or not, emphasized by a keyword search). In step S33, the processor 111 confirms requirements for a link (e.g., a QR code or a URL) with respect to the selected image. In step S34, the processor 111 confirms requirement for a partial image (e.g., the news IMG 52B or the provider IMG 53B). In step S35, the processor generates an image according to the confirmed requirements (i.e., specific instructions).

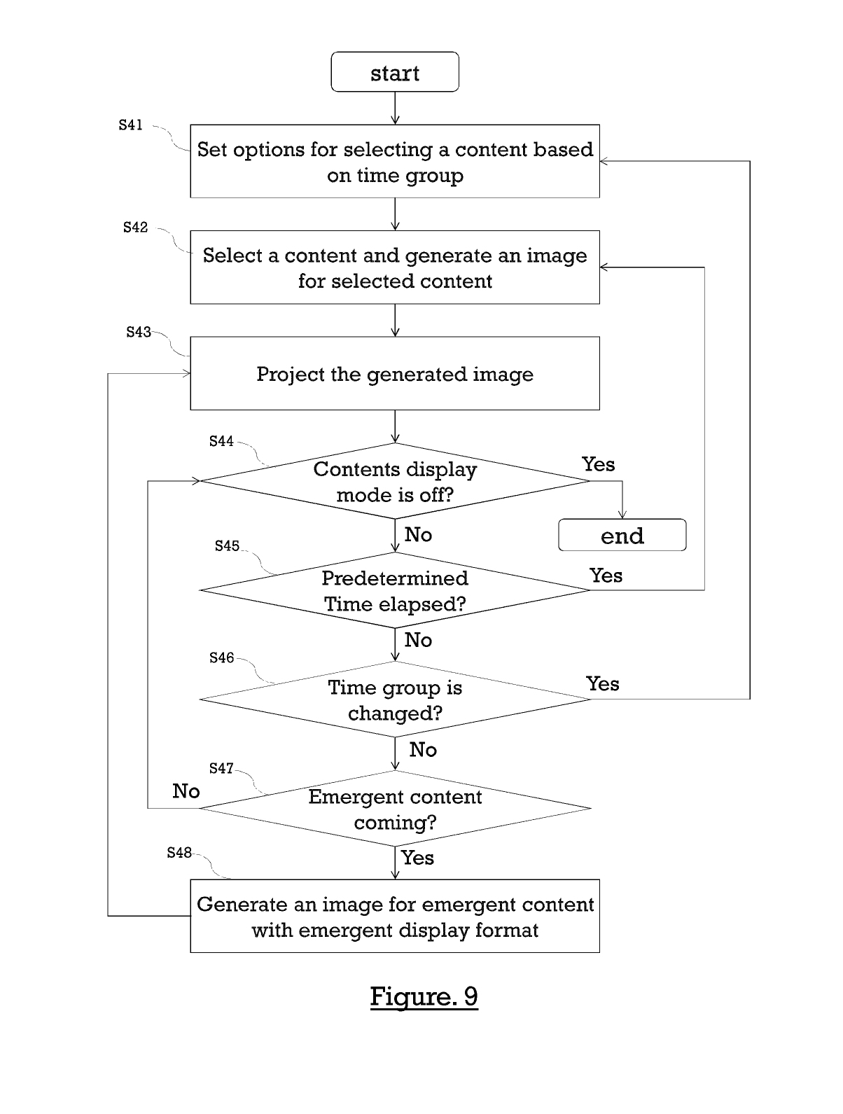

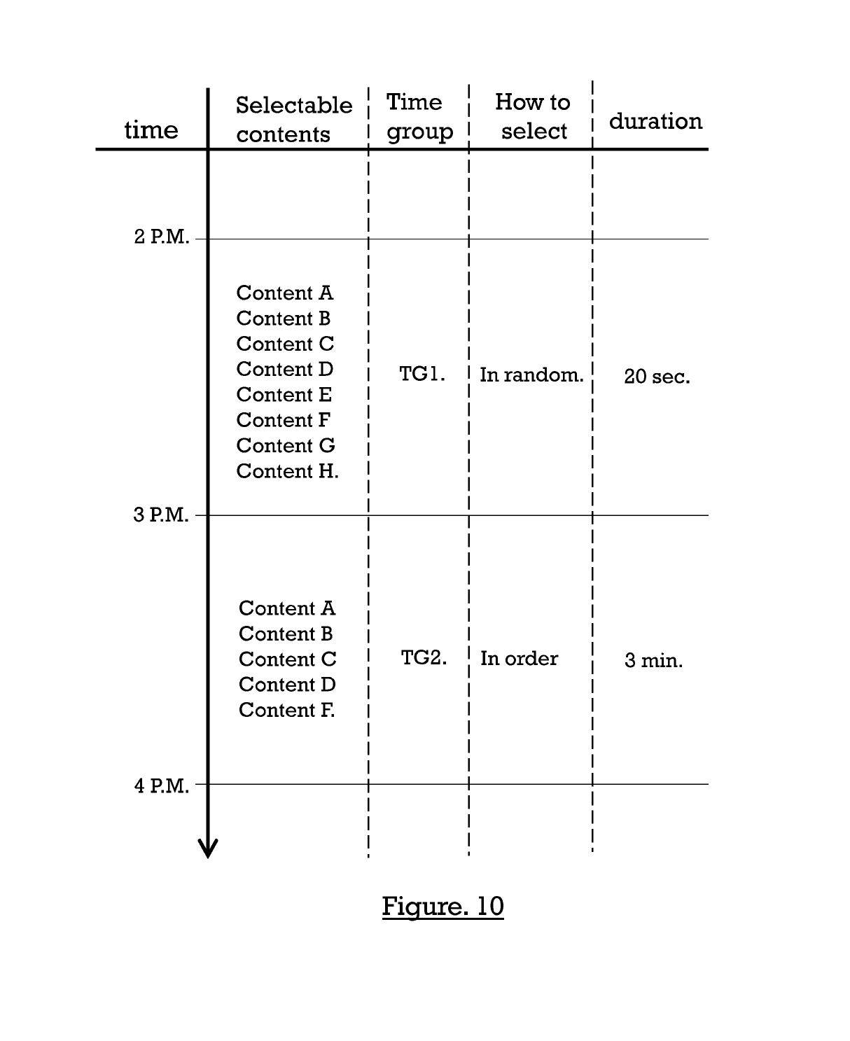

FIG. 9 shows an exemplary flowchart of a content output system, according to an aspect of the present disclosure. FIG. 10 shows an exemplary time schedule for contents, according to an aspect of the present disclosure. Herein, it is explained about processes for selecting a content and changing a projected content (image).

In step S41, the processor 111 sets options to be selected based on a time group. For instance, when it is a time group TG 1 which is between 2 PM and 3 PM as shown in FIG. 10, contents A-H are set as the options by the processor 111. Similarly, when it is a time group TG2 which is between 3 PM and 4 PM in FIG. 10, contents A-D and F are sets as the options by the processor 111. In step S42, the processor 111 selects a content from the set options under a predetermined selection regulation and generate an image for projecting based on the selected content. The selection regulation may be set for each time group. In case of FIG. 10, the processor 111 randomly selects one of contents A-H during the time group TG1 because the selection regulation during the time group TG1 is in random“. On the other hand, another selection regulation, in order”, is defined at the time group TG2. That is, during the time group TG2, the processor 111 selects a content from the contents A-H in accordance with a predetermined order. In step S43, the processor 111 projects the generated image based on the selected content via the lens unit 115. In step S44, if a contents display mode is turned off (Yes of S44), the projector 110 stops projecting the generated image. As long as the content display mode keeps going, the processor 111 projects any image based on the contents. The processor 111 may turn off the content display mode when receiving other image data from the peripheral computer 130 via the input IF 119, non-obtaining power from a power source, or receiving an instruction for the turn-off by a user input to the projector 110 with an input (e.g., a software or physical button, or a touch panel) on the projector 110, or a signal transmitted from the content server 210 and/or the computer 220. In step S45, when predetermined time (e.g., 20 seconds in TG1 or 3 minutes in TG2) has elapsed since projecting the generated image (Yes of S45), the flow returns to step S42, then the processor 111 selects a new content for generating and projecting a new image from the set options. In addition, the predetermined time which corresponds to a duration to be projecting one image may be set by the processor 111. In FIG. 10, the processor 111 changes a projected image every 20 seconds during the time group TG1 or every 3 minutes during the time group TG2. The processor 111 may set a plurality of durations for each content. In this case, for example, it is possible that an image based on the content A is projected for 10 seconds, but an image based on the content B is projected for 30 seconds. In step S46, when the time group is changed as 3 PM in FIG. 10, the flow returns to step S41, then processor 111 sets new options to be selected for generating and projecting a new image (e.g., setting contents A-D and H as the options at 3 PM in FIG. 10). In step S47, when the processor 111 does not receive an emergency content (No of S47), the flow returns to step S44. Therefore, the processor 111 keeps projecting the same image based on the same content unless the content display mode is off at step S44, the predetermined time predetermined time has elapsed since projecting an image at step S45, or the time group has been changed to the next one at step S46.

The emergency content is for example a breaking news of which the content providers 300 want to inform as soon as possible. Thus the emergency content has a higher priority than regular contents as the contents A-H during the time group TG1. Accordingly, when the processor 111 receives the emergency content from the content server 210 or the content providers 300 directly (Yes of step S47), the processor 111 generates a new image based on the emergency content with a specific instruction. The memory 112 has the specific instruction indicating a special or unique display format for such an emergency signal in advance. Otherwise, the specific instruction may be transmitted from the content server 210 or the content providers 300 directly together with the emergency content. After receiving the emergency content at step S47, the processor 111 projects the newly generated image based on the emergency contents at step S43. Therefore, the processor 111 changes the projected image to the new image based on the emergency content even if the content display mode is still on at step S44, the predetermined time has not elapsed since projecting an image at step S45, or the time group has not been changed to the next one at step S46. In other words, the new image based on the emergency content may interrupt the regular content projecting.

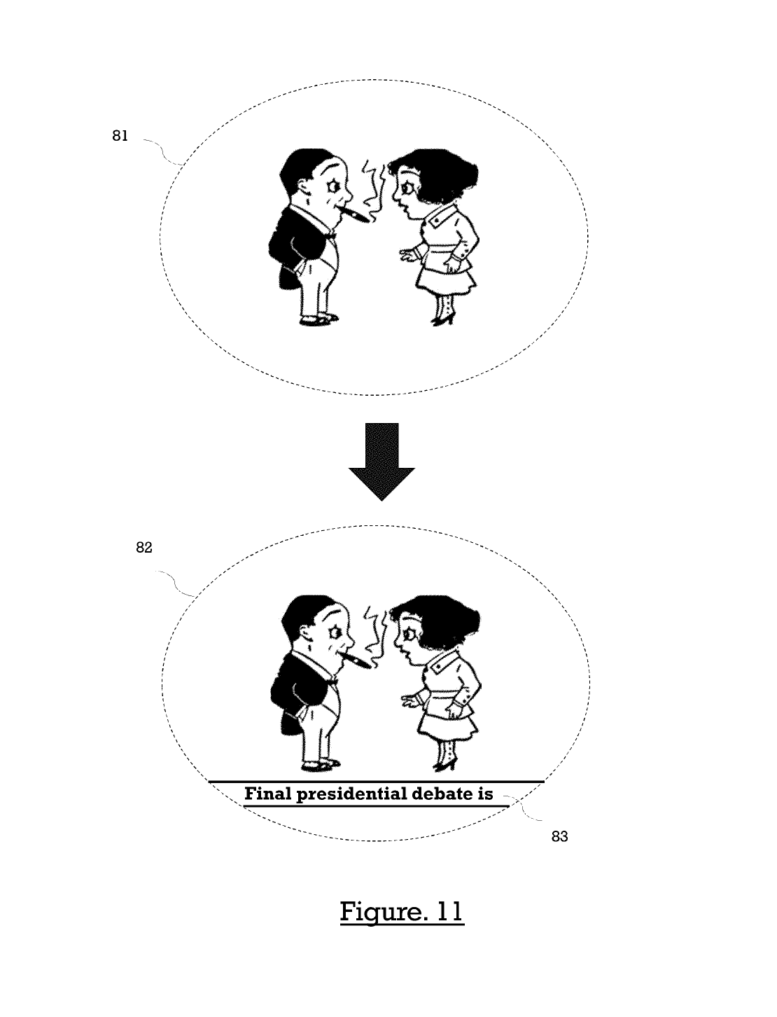

FIG. 11 shows an exemplary projected image with a content image, according to an aspect of the present disclosure. An image 81 is an image or movie projected by the projector 110. In other words, the image 81, as a normal image or movie (e.g., presentation slide or film), is not based on contents (e.g., news or Ads) transmitted from the content providers 300. The image 81 may be input from the peripheral computer 130 to the projector 110 or transmitted to the projector 110 from another entity different from the content providers 300 via the network 10. When the projector 110 is in an overlapping mode set by a user, the processor 111 accepts to overlap text data on the image 81 included in a selected content. Thereby, an overlapped image 82 with a text 83 is generated and projected. The selected content is projected with a different form compared to the content display mode as shown in FIG. 11. In addition, if the projector is in a non-overlapping mode, the processor 111 does not accept the overlapping and just projects the image 81 despite having any contents in the memory 112.

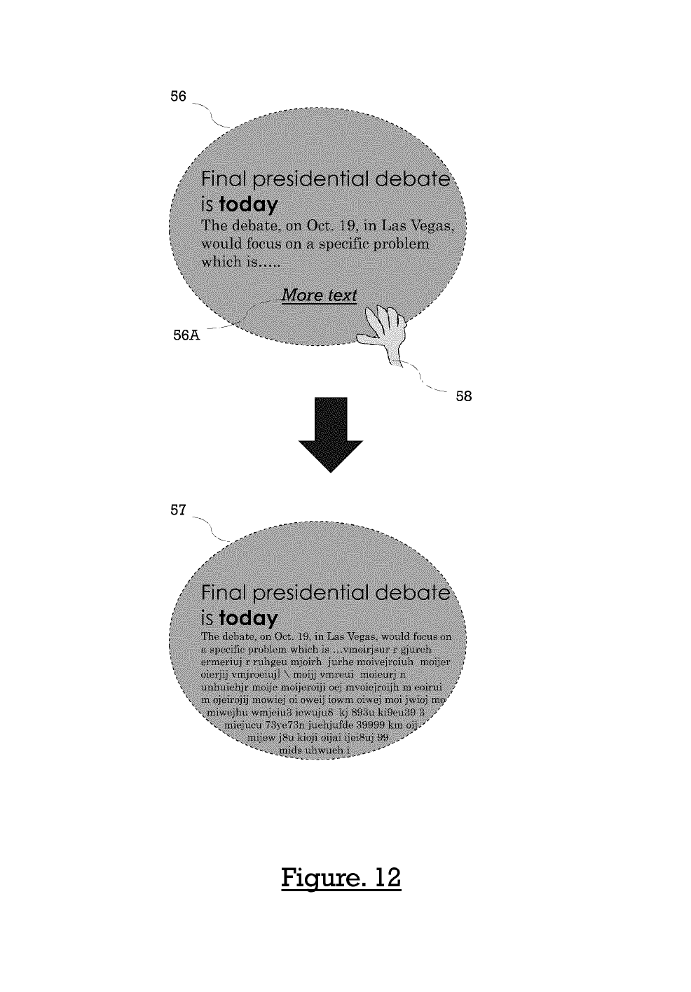

FIG. 12 shows an exemplary explanation for processes for projecting more text dada, according to an aspect of the present disclosure. FIG. 12 shows a projected image 56 with a link 56A described as “text more”. Here, the camera 117 of the projector 110 may capture an image for a projected area by the lens unit 15. Then the processor 111 may perform a well-known image processing on the captured image by the camera 117 in order to detect an object on the projected image. When the processor 111 detects a hand 58 by the image processing, the processor 111 may project a new image 57 which is generated based on the same content as the image 56. But the new image 57 includes more characters in a subtitle area to let people read detail information about the content, and a font size of subtitle characters in the new image 57 becomes smaller than the image 56. Alternatively, the human sensor 118 may be used for detecting a hand in place of the camera. The human sensor 118 is, for example, a distance sensor with an infrared light source. When the processor 111 detects a hand 58 by using the human sensor 118, the processor 111 may project the new image 57 which is generated based on the same content as the image 56.

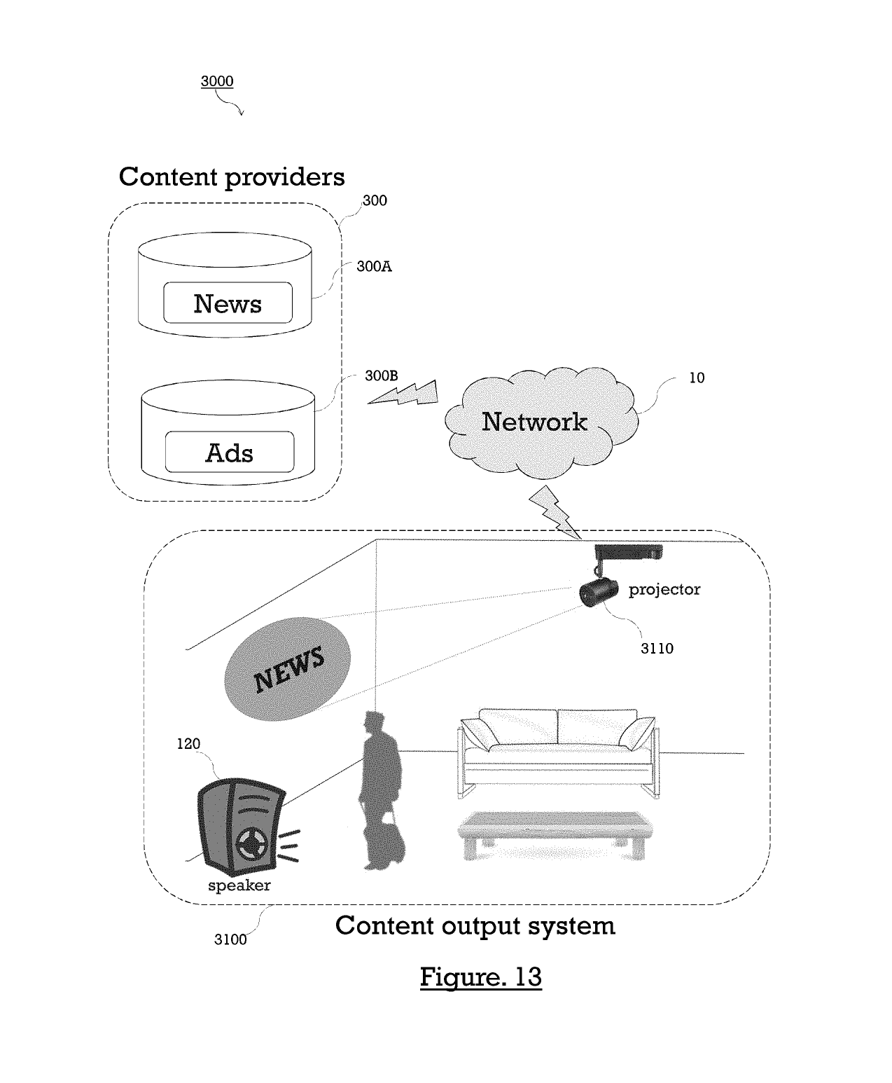

FIG. 13 shows an exemplary system for projecting contents transmitted from outside, according to an aspect of the present disclosure. FIG. 13 shows a system 3000, as an alternative example of the system 1000, for projecting contents transmitted via a network 10. The system 3000 does not include the content managing system 200. Instead, a projector 3110 of a content output system 3100 have a function of the content managing system 200. Thus the projector 3110 may receive directly contents from the content providers 300.

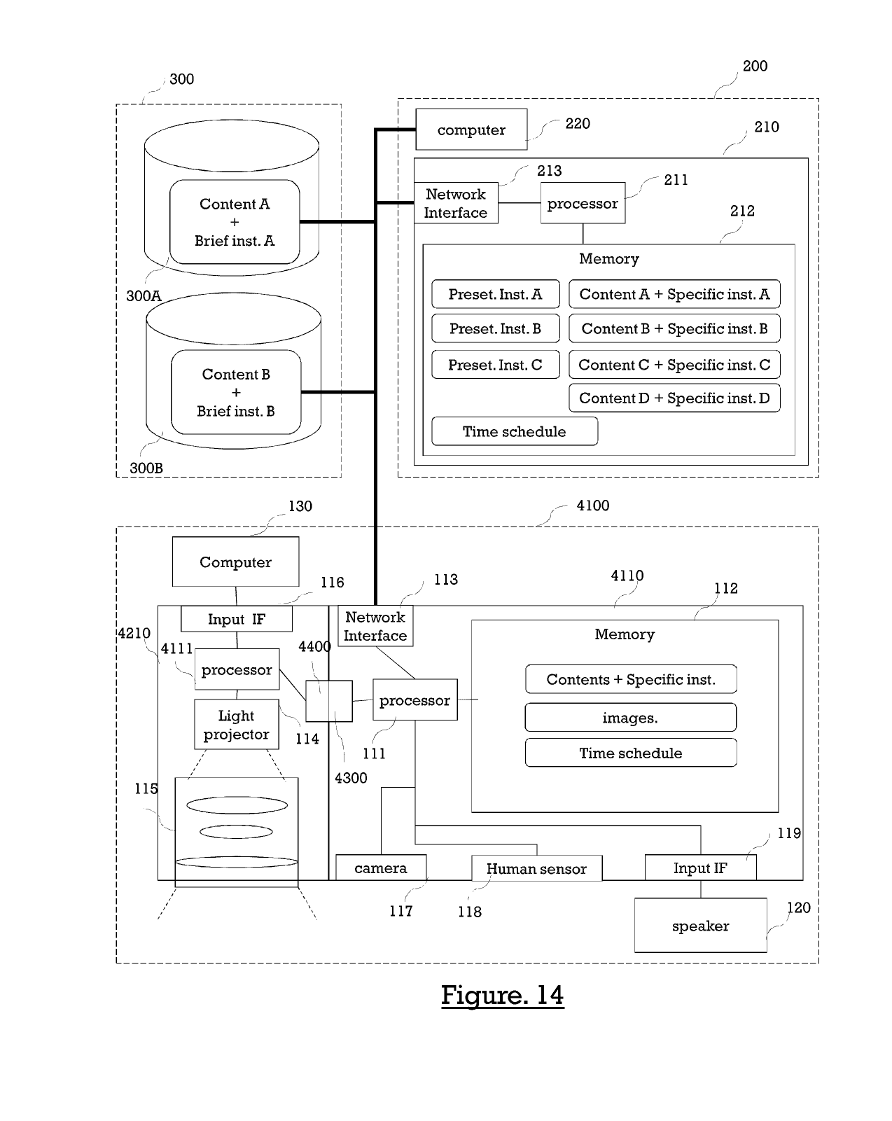

FIG. 14 shows an exemplary schematic of a system for projecting contents transmitted from outside, according to an aspect of the present disclosure. FIG. 14 shows a content output system 4100, as an alternative example of the content output system 100. The content output system 4100 could do the same things as the content output system 100, but configured by two devices. A first device is a general projector 4210 does have a function receiving contents transmitted from content server 210. Usually a processor 4111 of the general projector 4210 projects an image input by the computer 130. A second device is an external content receiver 4110 being connectable to the general projector 4210 via a connector 4300. The general projector also has a connector 4400 to be connected to the connector 4300. When the connector 4300 and 4400 (e.g., USB interface, Ethernet interface, HDMI interface or the like) are connected, the processor 111 transmits contents stored in the memory 112 to the processor 4111 of the general projector 4210 for projecting the contents by using the light projector 114 and the lens unit.

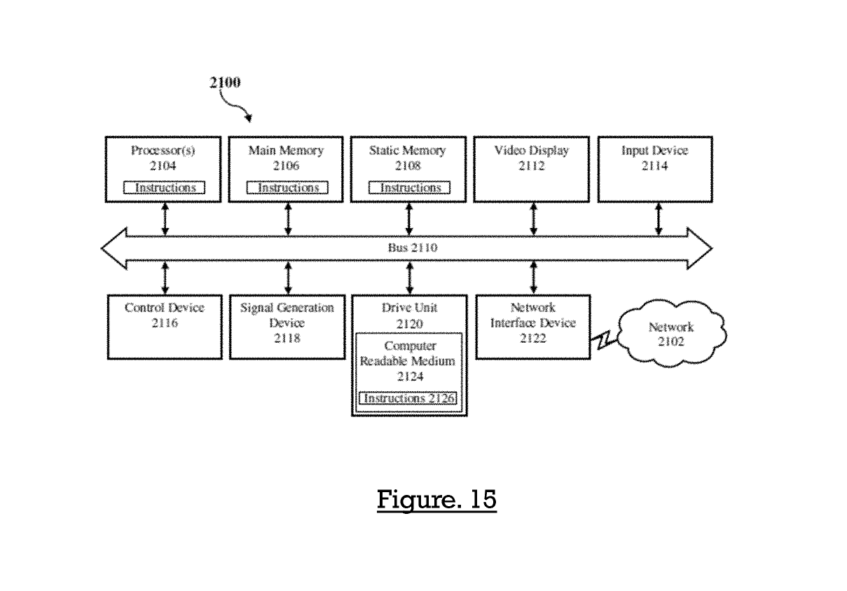

As illustrated in FIG. 15, the computer system 2100 includes a processor 2104. The processor 2104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 2104 is an article of manufacture and/or a machine component. The processor 2104 is configured to execute software instructions in order to perform functions as described in the various embodiments herein. The processor 2104 may be a general purpose processor or may be part of an application specific integrated circuit (ASIC). The processor 2104 may also be a microprocessor, a microcomputer, a processor chip, a controller, a microcontroller, a digital signal processor (DSP), a state machine, or a programmable logic device. The processor 2104 may also be a logical circuit, including a programmable gate array (PGA) such as a field programmable gate array (FPGA), or another type of circuit that includes discrete gate and/or transistor logic. The processor 2104 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 2100 includes at least one of a main memory 2106 and a static memory 2108. The main memory 2106 and the static memory 2108 can communicate with each other via a bus 2110. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 2100 may further include a video display device 2112, such as a liquid crystal display (LCD), an organic light emitting diode (OLED), a flat panel display, a solid state display, or a cathode ray tube (CRT). The video display device 2112 may be integrated with or physically separate from the components of the computer system 2100 described herein. For example, the video display device 2112 may comprise the display or signage.

Additionally, the computer system 2100 may include an input device 2114, such as a keyboard/virtual keyboard or touch-sensitive input screen or speech input with speech recognition. The computer system 2100 may also include a cursor control device 2116, such as a mouse or touch-sensitive input screen or pad, a microphone, etc. The computer system 2100 may also include a signal generation device 2118, such as a speaker or remote control, a disk drive unit 2120, and a network interface device 2122.

In a particular embodiment, as depicted in FIG. 15, the disk drive unit 2120 may include a computer-readable medium 2124 in which one or more sets of instructions 2126, e.g. software, can be embedded. Additionally or alternatively to the disk drive unit 2120, the computer system 2100 may comprise any additional storage unit, such as, but not limited to, a solid state storage or other persistent storage, which comprises the computer-readable medium 2124. Sets of instructions 2126 can be read from the computer-readable medium 2124. Further, the instructions 2126, when executed by a processor, can be used to perform one or more of the methods and processes as described herein. In a particular embodiment, the instructions 2126 may reside completely, or at least partially, within the main memory 2106, the static memory 2108, and/or within the processor 2104 during execution by the computer system 2100.

As described above, a system for projecting a content image comprising: a processor; a memory storing instructions, that when executed by the processor, cause the processor to perform operations including: receiving a plurality of content data each including at least text data transmitted from a content provider; receiving a plurality of instruction data each indicating a display format; selecting first content data from the received plurality of content data; generating a first image based on the selected first content data in accordance with first instruction data which is one of the plurality of instruction data and correspond to the first content data; and projecting by a projector the generated first image, wherein the first image includes at least characters generated by editing text data in accordance with a display format indicated by the first instruction.

As described above, in the system, the operations further include: selecting second content data from the received plurality of content data; generating a second image based on the selected second content data in accordance with second instruction data which is another one of the plurality of instruction data and corresponds to the second content data; stopping projecting the generated first image; and projecting the generated second image.

As described above, in the system, the first instruction data include a plurality of items to determine the display format, the first image is generated using a standard item as one of items to determine the display format when at least one of the plurality of items is not designated in the first instruction, wherein the standard item is applicable to the plurality of content data transmitted from the content provider.

As described above, in the system, the first instruction data indicate a category of the first content data; the first image is generated in accordance with one of a plurality of preset instruction data corresponding to the category indicated in the first content data.

As described above, in the system, the operations further include: selecting second content data from the received plurality of content data; generating a second image based on the selected second content data in accordance with standard instruction data stored in the memory when not receiving instruction data corresponding to the second content data, wherein the standard instruction data is applicable to another one of the plurality of content data transmitted from the content provider.

As described above, in the system, the first image includes text information and link information accessible to more information than the text information.

As described above, in the system, the first content data is selected in a first method during a first time period, and the second content data is selected in a second method during a second time period.

As described above, in the system, the operations further include: receiving third content data having higher priority than the first content data from one of the content providers during projecting the first image generated based on the first content data; generating a third image based on the third content data; stopping projecting the first image; and projecting the generated third image.

As described above, a method for projecting a content image, comprising: receiving a plurality of content data each including at least text data transmitted from a content provider; receiving a plurality of instruction data each indicating a display format; selecting first content data from the received plurality of content data; generating a first image based on the selected first content data in accordance with first instruction data which is one of the plurality of instruction data and correspond to the first content data; and projecting by a projector the generated first image, wherein the first image includes at least characters generated by editing text data in accordance with a display format indicated by the first instruction.

As described above, the method further comprising: selecting second content data from the received plurality of content data; generating a second image based on the selected second content data in accordance with second instruction data which is another one of the plurality of instruction data and corresponds to the second content data; stopping projecting the generated first image; and projecting the generated second image.

As described above, in the method, the first instruction data include a plurality of items to determine the display format, the first image is generated using a standard item as one of items to determine the display format when at least one of the plurality of items is not designated in the first instruction, wherein the standard item is applicable to the plurality of content data transmitted from the content provider.

As described above, in the method, the first instruction data indicate a category of the first content data; the first image is generated in accordance with one of a plurality of preset instruction data corresponding to the category indicated in the first content data.

As described above, method further comprising: selecting second content data from the received plurality of content data; generating a second image based on the selected second content data in accordance with standard instruction data stored in the memory when not receiving instruction data corresponding to the second content data, wherein the standard instruction data is applicable to another one of the plurality of content data transmitted from the content provider.

As described above, in the method, the first image includes text information and link information accessible to more information than the text information.

As described above, in the method, the first content data is selected in a first method during a first time period, and the second content data is selected in a second method during a second time period.

As described above, a system for projecting a content image comprising: a content manager that communicates with a plurality of content providers generating content data including at least text data via a network and a plurality of projectors projecting an image generated based on the content data generated by the content providers; wherein the content manager receives the content data and brief instruction data with respect to the received content data, translates the brief instruction data into specific instruction data that instructs a method for generating an image based on the content data, and transmits the content data and the specific instruction data with respect to the content data to the projectors.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A system for projecting a content image, the system comprising:
a processor;
a memory storing instructions, that when executed by the processor, cause the processor to perform operations including:
receiving a plurality of content data each including at least text data transmitted from a content provider;
receiving a plurality of instruction data each indicating a display format;
selecting first content data from the received plurality of content data;
generating a first image based on the selected first content data in accordance with first instruction data which is one of the plurality of instruction data and correspond to the first content data; and
projecting by a projector the generated first image, wherein
the first image includes at least characters generated by editing text data in accordance with a display format indicated by the first instruction.

2. The system according to claim 1, wherein the operations further include:
selecting second content data from the received plurality of content data;
generating a second image based on the selected second content data in accordance with second instruction data which is another one of the plurality of instruction data and corresponds to the second content data;
stopping projecting the generated first image; and
projecting the generated second image.

3. The system according to claim 1, wherein,
the first instruction data include a plurality of items to determine the display format,
the first image is generated using a standard item as one of items to determine the display format when at least one of the plurality of items is not designated in the first instruction, wherein the standard item is applicable to the plurality of content data transmitted from the content provider.

4. The system according to claim 1, wherein,
the first instruction data indicate a category of the first content data;
the first image is generated in accordance with one of a plurality of preset instruction data corresponding to the category indicated in the first content data.

5. The system according to claim 1, wherein the operations further include:
selecting second content data from the received plurality of content data;
generating a second image based on the selected second content data in accordance with standard instruction data stored in the memory when not receiving instruction data corresponding to the second content data, wherein the standard instruction data is applicable to another one of the plurality of content data transmitted from the content provider.

6. The system according to claim 1, wherein
the first image includes text information and link information accessible to more information than the text information.

7. The system according to claim 2, wherein
the first content data is selected in a first method during a first time period, and the second content data is selected in a second method during a second time period.

8. The system according to claim 1, wherein the operations further include:
receiving third content data having higher priority than the first content data from one of the content providers during projecting the first image generated based on the first content data;
generating a third image based on the third content data;
stopping projecting the first image; and
projecting the generated third image.

9. A method for projecting a content image, the method comprising:
receiving a plurality of content data each including at least text data transmitted from a content provider;
receiving a plurality of instruction data each indicating a display format;
selecting first content data from the received plurality of content data;
generating a first image based on the selected first content data in accordance with first instruction data which is one of the plurality of instruction data and correspond to the first content data; and
projecting by a projector the generated first image, wherein
the first image includes at least characters generated by editing text data in accordance with a display format indicated by the first instruction.

10. The method according to claim 9, further comprising:
selecting second content data from the received plurality of content data;
generating a second image based on the selected second content data in accordance with second instruction data which is another one of the plurality of instruction data and corresponds to the second content data;
stopping projecting the generated first image; and
projecting the generated second image.

11. The method according to claim 9, wherein
the first instruction data include a plurality of items to determine the display format,
the first image is generated using a standard item as one of items to determine the display format when at least one of the plurality of items is not designated in the first instruction, wherein the standard item is applicable to the plurality of content data transmitted from the content provider.

12. The method according to claim 9, wherein
the first instruction data indicate a category of the first content data;
the first image is generated in accordance with one of a plurality of preset instruction data corresponding to the category indicated in the first content data.

13. The method according to claim 9, further comprising:
selecting second content data from the received plurality of content data;
generating a second image based on the selected second content data in accordance with standard instruction data stored in the memory when not receiving instruction data corresponding to the second content data, wherein the standard instruction data is applicable to another one of the plurality of content data transmitted from the content provider.

14. The method according to claim 9, wherein
the first image includes text information and link information accessible to more information than the text information.

15. The method according to claim 10, wherein
the first content data is selected in a first method during a first time period, and the second content data is selected in a second method during a second time period.

16. A system for projecting a content image, the system comprising:
a content manager that communicates with a plurality of content providers generating content data including at least text data via a network and a plurality of projectors projecting an image generated based on the content data generated by the content providers; wherein
the content manager receives the content data and brief instruction data with respect to the received content data, translates the brief instruction data into specific instruction data that instructs a method for generating an image based on the content data, and transmits the content data and the specific instruction data with respect to the content data to the projectors.
